(19) United States
(12) Patent Application Publication
(10) Pub. No.: US 2010/0267583 A1
(43) Pub. Date: Oct. 21, 2010

(54) METHOD AND KIT FOR DETECTION OF HEPATITIS A VIRUS NEUTRALIZING ANTIBODIES

(75) Inventor: Ali AZIZI, Ottawa (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: VARIATION BIOTECHNOLOGIES INC., Gatineau (CA)

(21) Appl. No.: 12/760,858

(22) Filed: Apr. 15, 2010

Related U.S. Application Data
(60) Provisional application No. 61/169,344, filed on Apr. 15, 2009.

(51) Int. Cl. C40B 30/06; C40B 40/00

(52) U.S. Cl. 506/10; 506/13

(57) ABSTRACT

A rapid immunoassay method for the detection of anti-Hepatitis A Virus (HAV) neutralizing antibodies is described herein. This microplate-based enzymatic assay may be applicable in virological diagnostics, in evaluating the immunogenicity of candidate immunogenic compositions, such as HAV vaccines, or in quantifying functional neutralizing antibodies during the course of HAV infection.

### CROSS REFERENCE TO RELATED APPLICATIONS

This application claims the benefit of priority of U.S. Provisional Patent Application No. 61/169,344 filed Apr. 15, 2009, which is incorporated herein by reference in its entirety.

### FIELD OF THE INVENTION

The present invention relates generally to an antibody detection method and kit, and in particular to a method for detection of neutralizing antibodies, more particularly to a method for detecting neutralizing antibody response developed following exposure to a virus or viral antigen or an immunogenic composition.

### BACKGROUND OF THE INVENTION

Hepatitis A (HAV), a member of the Picornaviridae family, is a non-enveloped, positive-sense RNA virus with a pervasive worldwide transmission (Brown F. Intervirology 1989; 30:181-6). HAV causes acute liver infection with a sudden onset of symptoms such as fever and nausea (Nainan O V, Xia G, Vaughan G, Margolis H S. Clin.Microbiol.Rev. 2006; 19:63-79; Jelic O, Formet-Sapcevski J, Kovacevic L, Pandak N, Jelic D. Acta Med.lugosl. 1990; 44:565-76). The virus is transmitted via the fecal-oral route and infects approximately 1.4 million people every year (Chen H, Cantrell C R. Curr.Med.Res.Opin. 2006; 22:2489-96). The HAV genome encodes an approximately 2 kD single polyprotein which is autocatalytically processed into VP1, VP2, and VP3 structural proteins. HAV grows extremely slowly in cell cultures and often replicates without any visible cytopathic effects, unlike other members of the Picornaviridae family such as poliovirus and human rhinovirus (Stapleton J T, Raina V, Winokur P L et al. J. Virol. 1993; 67:1080-5; Zahn J, Vallbracht A, Flehmig B. Med.Microbiol.Immunol. 1984; 173:9-17; Gauss-Muller V, Lottspeich F, Deinhardt F. Virology 1986; 155:732-6).

The slow growth of HAV in cell cultures has proved to be problematic for the rapid detection of the virus (Pinto R M, Aragones L, Costafreda M I, Ribes E, Bosch A. Virus Res. 2007; 127:158-63; Gosert R, Egger D, Bienz K. Virology 2000; 266:157-69; Bishop N E, Anderson D A. Arch.Virol. 1997; 142:2161-78). Various in vitro assays have been developed to detect the presence of HAV neutralizing antibodies; however, these assays are time consuming (2-3 weeks in length), difficult to reproduce, and hard to interpret (Beales L P, Wood D J, Minor P D, Saldanha J A. J.Virol.Methods 1996; 59:147-54; Cao J, Meng S, Li C et al. J.Med.Virol. 2008; 80:1171-80; Kim S J, Jang M H, Stapleton J T et al. Virology 2004; 318:598-607; Konduru K, Virata-Theimer M L, Yu M Y, Kaplan G G. Virol.J. 2008; 5:155). An additional disadvantage is that most methods for the quantification of HAV have been limited to complex assays (Siegl G, deChastonay J, Kronauer G. J.Virol.Methods 1984; 9:53-67; Yeh H Y, Hwang Y C, Yates M V, Mulchandani A, Chen W. Appl.Environ.Microbiol. 2008; 74:2239-43; Sanchez G, Populaire S, Butot S, Putallaz T, Joosten H. D. J. Virol.Methods 2006; 132:160-5). Though HAV antibody can be detected through ELISA, the results are not reliable, demonstrate poor correlation with the potency of sera to neutralize HAV, and thus cannot predict a patient's resistance to HAV infection (Shouval D, Ashur Y, Adler R et al. Vaccine 1993; 11 Suppl 1:S9-14; Lemon S M, Jansen R W, Brown E A. Vaccine 1992; 10 Suppl 1:S40-S44). Additionally because the current neutralizing immunoassays for the detection of HAV-specific antibodies are laborious and require extended periods of time, they consequently increase the risk of contamination and may negatively affect the integrity of the cell monolayers, before the assay can be completed (Bishop N E, Anderson D A. Arch.Virol. 1997; 142:2161-78).

Thus, a simpler rapid and reproducible method is required for detecting and quantifying HAV neutralizing antibodies. Over the past few years, cytopathic variants of HAV with a shorter replication cycle (2 to 3 days) have been generated (Brack K, Frings W, Dotzauer A, Vallbracht A. J. Virol. 1998; 72:3370-6; Emerson S U, Huang Y K, Purcell R H. Virology 1993; 194:475-80; Gosert R, Egger D, Bienz K. Virology 2000; 266:157-69). A specific cytopathic variant of HAV has been described which retains normal antigenicity but has a more rapid rate of replication (Lemon S M, Murphy P C, Shields P A, Ping L H, Feinstone S M, Cromeans T, Jansen R W. J. Virol. 1991; 65:2056-65). The nucleotide sequence of this specific cytopathic HM175 virus variant has been submitted to GenBank under the following accession number (HAV175/18f clone B; M59808) and deposited with American Type Culture Collection as VR-1402™. These HAV strains cause acute rather than persistent infections, and produce a much higher viral yield than non-cytopathic variants.

To date no assay has been available with the ability to detect HAV infectivity and HAV-neutralizing antibodies rapidly. There is a need to develop an HAV neutralizing antibody detection assay that is rapid, sensitive, specific and reproducible.

### SUMMARY OF THE INVENTION

It is an object of the present invention to obviate or mitigate at least one disadvantage of previous in vitro assays developed to detect the presence of HAV neutralizing antibodies.

In a first aspect, the present invention provides a detection assay for HAV neutralizing antibodies.

According to a further aspect of the invention, there is provided a rapid in vitro method for detecting hepatitis A virus (HAV) neutralizing antibodies in sera comprising evaluating HAV neutralizing antibody response after exposure of HAV-permissive cells to the sera in combination with a rapidly replicating HAV.

Additionally, another aspect of the invention provides a rapid in vitro method for detecting hepatitis A virus (HAV) neutralizing antibodies in sera, the method comprising: incubating the sera with a rapidly replicating HAV to form a sera-HAV mixture; incubating the sera-HAV mixture with pre-seeded HAV permissive cells; fixing the cells; and detecting HAV-VP3 in cells by incubating the cells with an anti-HAV VP3 antibody. In this instance, the HAV-VP3 in cells is indicative of HAV growth in said cells; suppressed HAV growth being indicative of HAV neutralizing antibodies in sera.

According to another aspect of the invention there is provided a kit for detecting hepatitis A virus (HAV) neutralizing antibodies in sera. The kit comprises a rapidly replicating cytopathic variant of HAV for incubating with sera; HAV permissive cells comprising fetal rhesus monkey kidney FRhK-4 cells for incubating with a mixture of sera and said cytopathic variant of HAV; and an anti-HAV VP3 antibody.

These different aspects of the present invention provides a rapid, sensitive, specific, and reproducible microplate-based assay for evaluating HAV neutralizing antibody responses, using a cytopathic variant. Advantageously, infectivity can be detected after one replication cycle of HAV. In a rapidly replicating variant, the cycle may permit detection within 2 to 3 days instead of a longer time of up to about 2 weeks, if a typical HAV was to be used.

The present detection assay is useful for evaluating HAV neutralizing antibody responses developed in response to viral infection, an HAV vaccine and/or any immunogenic composition based on HAV and used to elicit an HAV neutralizing antibody response.

The assay relies principally on a cytopathic variant of HAV (HM175/18f), HAV-permissive FRhK-4 cells, and a monoclonal antibody to the HAV-VP3 structural protein.

Other aspects and features of the present invention will become apparent to those of ordinary skill in the art upon review of the following description of specific embodiments of the invention in conjunction with the accompanying Figures.

### BRIEF DESCRIPTION OF THE DRAWINGS

Embodiments of the present invention will now be described, by way of example only, with reference to the attached figures.

FIG. 1 shows Intracellular staining for HAV in infected versus uninfected FRhK-4 cells after 3 days.

FIG. 2 shows the microplate-based enzymatic method for measuring HAV in infected versus uninfected FRhK-4 cells over 1-3 days.

FIG. 3 shows the neutralization of HAV virus in vaccinated human and rhesus macaque sera.

### DETAILED DESCRIPTION

Generally, the present invention provides an in vitro assay for detecting hepatitis A virus (HAV) neutralizing antibodies in cells or sera samples, the assay comprising evaluating HAV neutralizing antibody responses developed in response to viral infection, an HAV vaccine, and/or an immunogenic composition based on HAV which is used to elicit an HAV neutralizing antibody response.

The term “assay” as used herein generally refers to a method of laboratory analysis, and may be used interchangeably with the term “method”.

The term “rapid” as used herein refers to the time required, relative to a conventional or typical period of time that may be expected for the hepatitis A virus. For example, a “rapid in vitro method” may be one that is expected to produce results within days, for example 2 to 3 days, as opposed to weeks, such as 1 to 2 weeks. A “rapidly replicating HAV may be one that replicates more quickly than a typically known HAV strain, for example, taking 50% of the time typically expected for replication. Preferably, the rapidly replicating strain may take less than 40%, or less than 30% of the time typically expected for replication.

A rapid in vitro method for detecting hepatitis A virus (HAV) neutralizing antibodies in sera is described herein. In one embodiment, the method comprising evaluating HAV neutralizing antibody response after exposure of HAV-permissive cells to the sera in combination with a rapidly replicating HAV, also reference herein as a “cytopathic variant” of HAV. The rapidly replicating HAV may comprise HM175/18f-HAV, also referenced herein interchangeably as “HM175/18f”, which is a previously reported virus (Binn et al., Vaccine, vol 10, Suppl 1, 1992).

The method may advantageously be used in sera is derived from a subject that has been exposed to or suspected of exposure to HAV infection, an HAV vaccine, or an immunogenic composition based on HAV used to elicit an HAV neutralizing antibody response. The method may be used as a confirmatory measure to confirm that a subject has not had any exposure to HAV infection. Quantification of the level of neutralizing antibodies in sera can also be used to determine a subject's response to an exposure, for the purposes of determining efficacy of a candidate immunogenic composition.

The method permits a result to be obtained with one replication cycle of HAV being completed prior to evaluation of HAV neutralizing antibody response.

The cells to be used in the method may be “HAV-permissive cells” derived from a source such as fetal rhesus monkey kidney FRhK-4 cells. Such permissive cells permit entry and growth of HAV. Such cells may be aliquotted into microplates, tubes, or other vessels or containers so as to be “pre-seeded” therein, prior to the addition of the sera in combination with rapidly replicating HAV. In an exemplary embodiment, the method may be a microplate-based method.

The evaluating of the HAV neutralizing antibody response may comprise detecting HAV growth in said HAV-permissive cells using with an antibody to HAV, such as an antibody to HAV-VP3 structural protein. In this instance, suppressed HAV growth is indicative of the presence HAV neutralizing antibodies and can be detected by a low level of HAV-VP3 structural protein (low HAV replication). Relative growth of HAV may be determined in samples of sera relative to a control, a series of control values, or a control panel known to contain certain quantities of HAV neutralizing antibody. For example, the method may involve evaluating HAV neutralizing antibody response by comparing the ability of sera to neutralize HAV relative to a virus control value.

A further embodiment of the method described herein comprises a rapid in vitro method for detecting hepatitis A virus (HAV) neutralizing antibodies in sera. The method may comprise incubating the sera with a rapidly replicating HAV to form a sera-HAV mixture; incubating the sera-HAV mixture with pre-seeded HAV permissive cells; fixing the cells; and detecting HAV-VP3 in cells by incubating the cells with an anti-HAV VP3 antibody. In this embodiment, HAV-VP3 in cells is indicative of HAV growth in said cells; suppressed HAV growth being indicative of HAV neutralizing antibodies in sera. This antibody is but one example of the antibodies which may be used to detect the presence of growth of HAV in the permissive cells, and it is understood that other antibodies may be used.

In order to detect the antibody, such as the anti-HAV-VP3, which may be referred to herein as the “primary” antibody, any method of detection as can be determined by of person of skill in the art may be use. For example, the primary antibody itself may be labeled in a way that has no impact on binding. Further, the primary antibody may be detected by the use of a secondary antibody, such as horseradish peroxidase (HRP)-conjugated goat anti-mouse antibody. ELISA may be used for detection, or other methods capable of detecting label.

A kit for detecting hepatitis A virus (HAV) neutralizing antibodies in sera is described herein, to permit use of the method described herein. The kit may comprise a rapidly replicating cytopathic variant of HAV for incubating with sera; HAV permissive cells comprising fetal rhesus monkey kidney FRhK-4 cells for incubating with a mixture of sera and said cytopathic variant of HAV; and an anti-HAV VP3 antibody. The rapidly replicating cytopathic variant of HAV for inclusion in the kit may be HM175/18f-HAV. A cell fixative may optionally be included in the kit. A detectable antibody to the anti-HAV VP3 antibody may be included in the kit, for example, a HRP-conjugated goat anti-mouse antibody.

The kit may optionally comprise instructions for use in accordance with the method described herein.

In one embodiment of the present invention there is provided a rapid in vitro assay for detecting hepatitis A virus (HAV) neutralizing antibodies in sera of animals or humans either infected with HAV, or treated with a HAV vaccine or other immunogenic composition based on HAV. The assay comprises collecting sera samples, incubating sera samples with the rapidly replicating cytopathic variant HM175/18f-HAV virus, isolating the incubated sera-virus mixture, adding the mixture to pre-seeded HAV-permissive cells, incubating the pre-seeded cells with the sera-virus mixture for a period of time, fixing the cells, incubating the fixed cells with anti-HAV VP3 primary antibody and a secondary antibody with a conjugated marker enzyme, detecting the secondary antibody by adding an appropriate chromogenic, fluorogenic or luminogenic enzyme substrate, stopping the reaction, and conducting an optical density (OD) reading at the appropriate wavelength, and detecting any HAV neutralizing antibody response.

The pre-seeded HAV-permissive cells may be, for example, fetal rhesus monkey kidney cells; FRhK-4 cells.

The period of time for incubating the rapidly replicating cytopathic variant HM175/18f-HAV virus with sera samples may be set as a time period appropriate for such an incubation, such as about 3 hours.

The period of time for incubating the pre-seeded cells with the sera-virus mixture may be set as a time period appropriate for such an incubation, such as from about 1 to 5 days. An exemplary period of time may be about 3 days.

The cells may be fixed in any convenient way known in the art, for example with 80% acetone in PBS for 10 minutes.

The conjugated marker enzyme may be for example horseradish peroxidase (HRP).

The appropriate chromogenic, fluorogenic or luminogenic enzyme substrate for use in detecting the secondary antibody may be for example 3,3′,5,5′-Tetramethylbenzide (TMB) which can be used with HRP (TMB HRP enzyme substrate). An appropriate wavelength for conducting an optical density reading of TMB substrate would be, for example, 450 nm.

HAV infectivity was measured first by flow cytometry, and subsequently by a microplate-based enzymatic assay. Since newly formed HAV virions tend to remain entrapped within cells, permeabilization of the cells at the time of fixation and during their preparation for the flow cytometry detection method was necessary to maximize the reactivity of VP3 antibody with cell-associated virus.

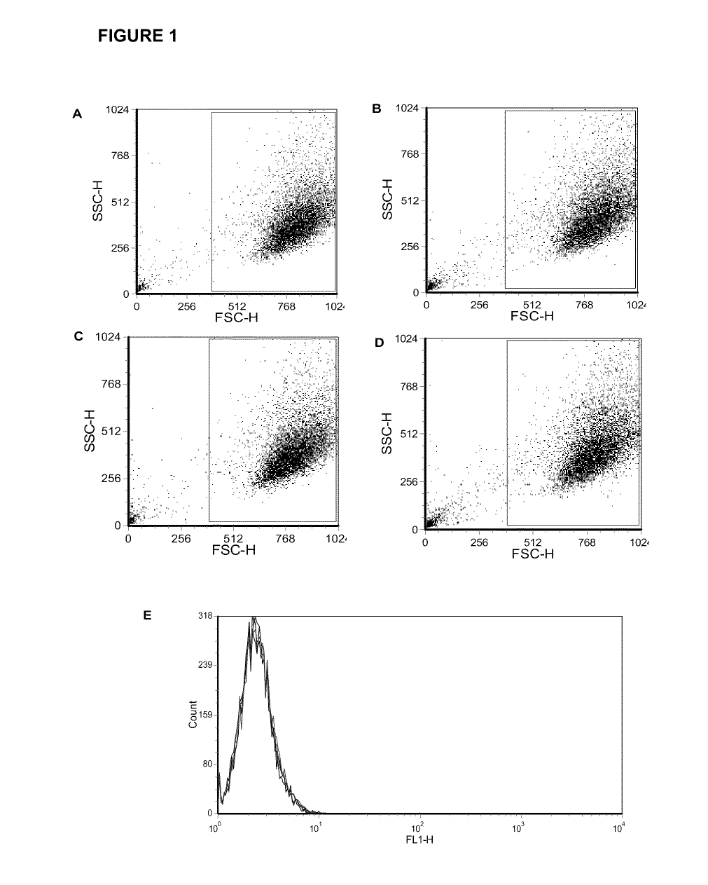

This method has already been used for the detection and quantification of rabies neutralizing antibodies (Bordignon J, Pires Ferreira S C, Medeiros Caporale G M et al. J. Virol.Methods 2002; 105:181-6; Bordignon J, Comin F, Ferreira S C, Caporale G M, Lima Filho J H, Zanetti C R. Rev. Inst.Med.Trop.Sao Paulo 2002; 44:151-4). However, HAV infected vs uninfected FRhK-4 cells were not differentiated over 1-5 days (FIG. 1) using flow cytometry, regardless of the amount of virus or concentration of antibodies used.

FIG. 1 shows the Intracellular staining for HAV in infected vs uninfected FRhK-4 cells after 3 days. Infected and uninfected cells were fixed, permeabilized and stained with a primary mouse anti-HAV VP3 antibody followed by a FITC-conjugated secondary antibody. Staining for HAV was evaluated by flow cytometry. FIG. 1, part A shows flow cytometry results for uninfected cells. FIG. 1, part B shows flow cytometry results for infected cells. FIG. 1, part C shows flow cytometry results for uninfected cells stained with secondary antibody alone. FIG. 1, part D shows flow cytometry results for infected cells stained with secondary antibody alone. FIG. 1, part E shows Histogram overlays of FIG. 1, from parts A to D.

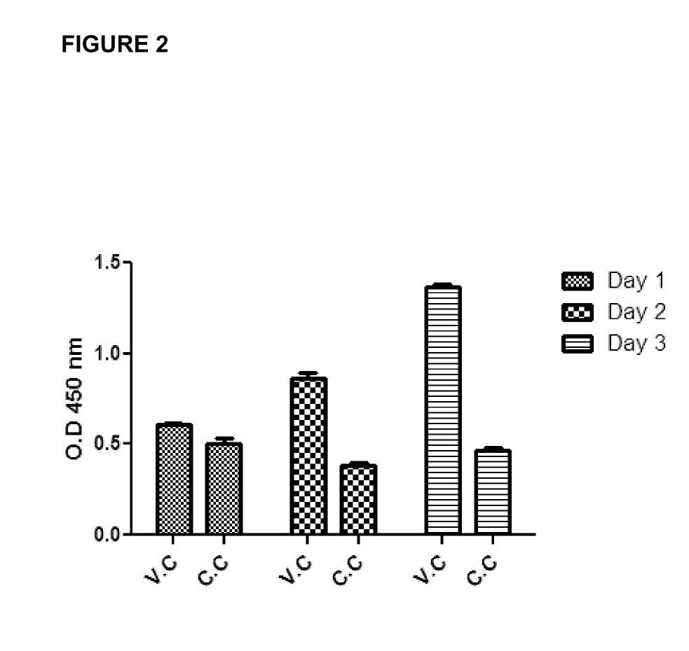

Thereafter, the infectivity of FRhK-4 cells was measured by a microplate-based enzymatic method, based on quantifying the amount of HAV-VP3 antigen present in the infected cells. FRhK-4 cells were inoculated with different amounts of HM175/18f-HAV virus and incubated 3 days. At daily intervals, cells were fixed and HAV-VP3 antigen quantified by direct ELISA of cell-associated viral VP3 antigen. At 0.5×10⁵ pfu/well, viral antigen became detectable within 48 hrs after HAV inoculation, and after 72 hrs the signal:noise ratio between infected vs non-infected cells was easily discernable, and approached 3:1 (FIG. 2).

FIG. 2 shows a microplate-based enzymatic method for measuring HAV in infected vs uninfected FRhK-4 cells over 1-3 days. Infected and uninfected FRhK-4 cells were fixed and HAV-VP3 antigens quantified by direct ELISA (VC: virus control; CC: cell control).

Thus, HAV infection may be detected significantly sooner than in previously described assays. Based on these results, sera from humans, rabbits, and monkeys vaccinated with Havrix™ 1440 was assessed for the ability to neutralize HAV. Several conditions, such as the strain and amount of virus, density and type of cells, and concentration and isotypes of primary and secondary antibodies were optimized. Four-fold dilutions of four human sera were set up in 96-well plates and incubated with HM175/18f-HAV virus. After a 2 hr incubation at 37° C., virus and sera mixtures were added to the pre-seeded cells and the plates were incubated at 37° C. for 3 days. Cells were fixed, and reacted with anti-HAV VP3 primary antibody and HRP-conjugated goat anti-mouse secondary antibody. After addition of the chromogenic substrate, the colorimetric reaction was stopped and the optical densities at 450 nm were read on a microplate reader.

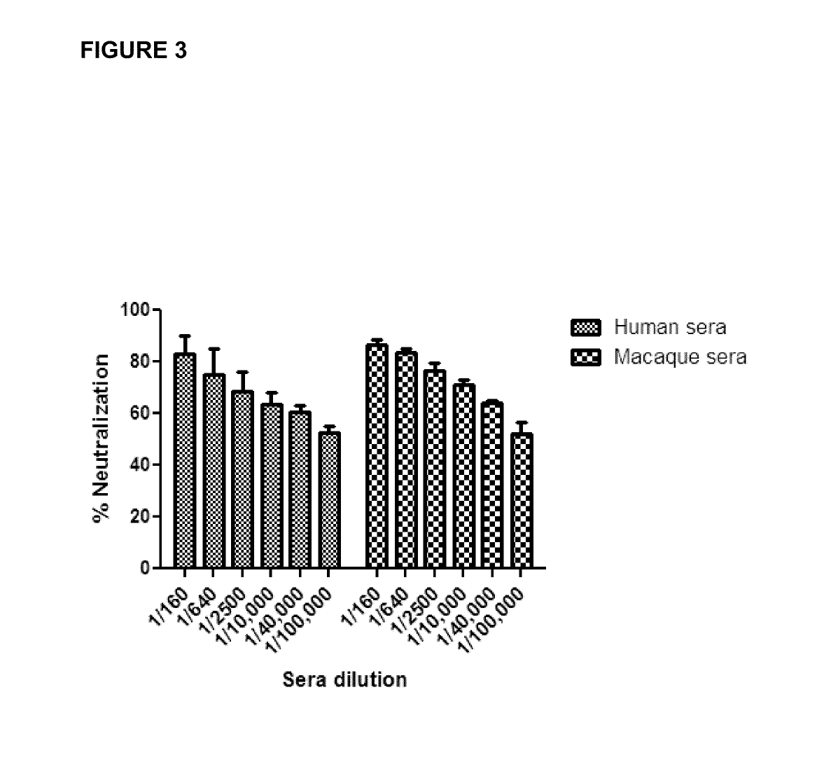

FIG. 3 shows the neutralization of HAV virus in vaccinated human and rhesus macaque sera. Serum samples from humans and monkeys (n=3) immunized with Havrix™ 1440 were collected 2 weeks after the last vaccination. Diluted sera samples were incubated with HM175/18f-HAV virus for 2 hours and then added to pre-seeded FRhK-4 cells. The plates were developed after 3 days as described herein in the Examples, and the percent neutralization was calculated. Data shown are the group mean±SE. All sera dilutions from tested (up to 1/100,000) were able to neutralize the virus by >50%, as compared to the virus control (FIG. 3). Control sera (non-vaccinated) were not able to neutralize the HAV virus for over % 10-15 in 1/40 dilution. One difference between the present method and previously described methods is that previous methods typically require a higher yield of HAV replication, while the present method is based on approximately only one replication cycle. In addition, most conventional methods require cell destruction to release cell-associated viruses. However, in the present assay, fixation may be used, for example a 10 minute fixation by acetone.

A general explanation of a particular embodiment of the invention is provided below.

In a particular embodiment of the invention, sera is obtained from a subject, for example from monkeys or humans exposed to HAV infection, or vaccinated with HAV vaccine or another immunogenic composition. The sera may contain some level of HAV neutralizing antibodies, or a “HAV neutralizing antibody response”. These neutralizing antibodies offer the subject protection from subsequent exposure to HAV infection. In clinical trials or other experimental setting, it is desirable to quickly determine the level of neutralizing antibody response in sera, and the method described herein permits rapid evaluation of the presence and/or level of HAV neutralizing antibodies.

Sera is preincubated with a rapidly replicating cytopathic HAV variant that it grows faster than usual strains. Depending on the presence or level of neutralizing antibodies in the sera, some amount of the rapidly growing HAV will be neutralized by the neutralizing antibodies in the sera. The sera virus mixture is then incubated with HAV permissive cells in which HAV can grow. Only the HAV that has not been neutralized by neutralizing antibodies in the sera preincubation, will now grow in the cells. The fast growing nature of the HAV variant is an advantage because HAV will grow rapidly in the cells (if not neutralized by neutralizing antibodies).

In this embodiment, cells are fixed and treated with a primary antibody to HAV (anti-HAV VP3) which binds to any HAV that has grown in the cells. Specifically, the antibody will bind to the HAV VP3 structural protein in HAV that has not been neutralized by neutralizing antibodies during the preincubation of the sera with the HAV variant. Subsequently, a second antibody to the first antibody is used to quantify anti-HAV VP3 by some means of detection. The amount detected indicates, and can thus be correlated to, the amount of virus that was not neutralized by the neutralizing antibodies present in the sera.

By detecting HAV using anti-HAV VP3 antibody, the neutralizing antibodies are not detected directly, but instead it is the virus that was not neutralized by neutralizing antibodies that is detected. For example, if a subject is vaccinated and the vaccine is effective, the serum of the subject will have a large amount of HAV neutralizing antibodies therein. If the instant method is used to assess this sera, upon preincubation of the sera with the rapidly replicating cytopathic variant HAV, most of the virus will be neutralized by neutralizing antibodies. When the sera-HAV mixture is then incubated with HAV permissive cells capable of growing HAV, not much of the virus will grow because most of the virus will have been neutralized.

After fixing cells and treating with the “primary” antibody: anti-HAV VP3, only a small amount of the primary antibody will bind because very little HAV will have grown after most virus was neutralized. A “secondary” antibody capable of detecting the primary antibody is used, and is labelled in an appropriate way for detection. Thus, an indication of the amount of HAV is evaluated as an indirect indication of the amount of HAV neutralizing antibodies in the sera. If there the sera was high in neutralizing antibodies, a low level of HAV will be detected as a result of the instant method. If neutralizing antibodies were low or absent in the sera, then a high level of HAV will be detected in the instant assay. By using a rapidly replicating HAV in the instant method, virus grows quickly in cells, and these assays can take days instead of weeks, as would be the case with slower replicating strains.

### EXAMPLES

### Cells and Virus

Fetal rhesus monkey kidney (FRhK-4) cells and HM175/18f, a cell culture-adapted, cytopathic variant of the HM175 strain of HAV were obtained. FRhK-4 cells were grown in IMDM (Hyclone, Thermo Fisher Scientific) supplemented with 4 mM L-Glutamine, 0.4% HEPES, 10% heat-inactivated fetal bovine serum (FBS) (Hyclone, Thermo Fisher Scientific) and 1% penicillin/streptomycin (Cellgro) at 37° C. and 5% CO₂. Infection media contained 2% FBS. Confluent cell monolayers were washed with PBS (Fisher) and trypsinized with 0.2% Trypsin-EDTA solution (Sigma). HM175/18f, a cell culture-adapted, cytopathic variant of the HM175 strain of HAV was propagated in FRhK-4 cells and virus titre was quantified by plaque assay.

Sera Samples

Serum samples from rhesus monkeys immunized with commercial HAV vaccine (Havrix™ 1440, GlaxoSmithKline) were collected approximately 2 weeks after the second round of two rounds of vaccinations. Animal procedures were carried out at Frontier Biosciences Inc. (Chengdu, P. R. China) in accordance with approved animal care protocols. Human serum was collected from volunteers who had been vaccinated with two doses of HAV vaccine. All serum samples were heat-inactivated for 30 minutes at 56° C. prior to use.

Cytopathic Plaque Assay

Confluent FRhK-4 monolayers in 12-well plates (Costar) were infected with 10-fold serial dilutions of 100 μl HM175/18f in PBS. After 60 min of adsorption at 37° C. in 5% CO₂, infected monolayers were overlaid with mixture of agarose type II and minimum essential medium (2×MEM) supplemented with 2 ml of 7.5% sodium bicarbonate, 4 ml of 1M HEPES, 2 ml nonessential amino acids, 1,000 U/ml streptomycin, 2 mg/ml kanamycin, 2,000 U/ml nystatin, 80 mM L-glutamine, and 4 ml fetal bovine serum (Sigma-Aldrich). After incubation for 5 days, cell monolayers were fixed with 3.7% formalin (for 1 hr minimum) and stained with 0.1% crystal violet. Excess stain was removed by washing with water. The number of plaques per well were counted and the virus concentration was determined based on the sample dilution and the volume inoculated into the wells (Binn, L N et al. Vaccine. 1992; 10: S102-105).

Flow Cytometry

Confluent FRhK-4 monolayers were infected with 200 μl of 1×10⁶ PFU/ml HM175/18f in a final volume of 2 ml in PBS, for 2 hours, rocking every 15 minutes, at 37° C. For every time point examined, infected or control mock-infected cells were washed with PBS, trypsinized with 2 ml trypsin, and resuspended at a density of 600,000 cells/ml. The cells were fixed and permeabilized with BD Fix/Perm reagent, according to the manufacturer's instructions (BD Biosciences). After permeabilization, cells were washed and stained with an optimized dilution of mouse monoclonal anti-HAV VP3 antibody (Abcam) for half an hour at 4° C. After washing twice, the cells were centrifuged and stained with various amounts of FITC-conjugated rat anti-mouse IgG1 antibody (Becton Dickinson) for half an hour at 4° C. Cells were washed 2 times and analyzed by FACScan (Becton Dickinson). Histogram overlays were created using FCS Express version 3 software.

Microneutralization Assay (MNA)

FRhK-4 cells were seeded in 96-well flat-bottomed plates at a density 2.5×10³ cells/well (Corning) with IMDM media supplemented with 10% FCS and 1% penicillin/streptomycin. The next day, cells were washed with PBS and media was replaced with 100 μl IMDM+2% FBS and 1% penicillin/streptomycin. Sera and control samples were serially diluted in a 96-well round-bottomed plate in a 100 μl final volume, with 2% FBS-IMDM. Wells designated as the virus control (virus alone) received 200 μl of HAV diluted in 2% FBS-IMDM. Wells designated as the cell control (cells alone) received 200 μl of 2% FCS-IMDM. 100 μl of diluted hepatitis A virus (1×10⁶ pfu/ml) was then added to all wells but cell control wells. Sera and virus were incubated together for 2 hours at 37° C. After incubation, 100 μl of the sera and virus mixture were added to the plates seeded with FRhK-4 cells. After 3 days, cell media was decanted off and plates were washed once in 200 μl of PBS. PBS was decanted, and cells were fixed with 100 μl of cold 80% acetone in PBS for 10 minutes, at room temperature. Acetone was then decanted and plates were air-dried for 20 minutes, inverted over the front air grille of a biosafety cabinet to ensure evaporation of the fixative. Plates were then washed 5 times in 1×PBS (Fisher)+0.05% Tween-20 (Sigma) and incubated for 1 hour in the dark with 100 μl of mouse anti-HAV VP3 primary antibody (Abcam) diluted 1/100 in 5% FBS-PBS. Plates were then washed 5 times in PBS-T-20 and incubated for 1 hour in the dark with 100 μl of HRP-conjugated goat anti-mouse IgG-Fc secondary antibody (Bethyl) diluted 1/10,000 in 5% FBS-PBS. Plates were then washed again 5 times in PBS-T-20 and developed with 100 μl of TMB substrate (BioFX Laboratories) for 12 minutes. 100 μl of TMB-Stop solution (BioFX Laboratories) was added to stop the reaction. Plates were then read on a microplate reader (Emax, Molecular Devices) at 450 nm. Neutralization was defined as the ability of serum to neutralize HAV by >50%, as compared to the virus control.

Percent neutralization was calculated by the following formula, using mean OD values from virus control (VC), cell control (CC) and serum sample wells:

$$[ VC ] - [ CC ] = SN 1 \\ [ VC ] - [ OD obtained for a dilution of sera ] = SN 2$$

$$\frac{SN 2 \times 100}{SN 1} = \% Neutralization$$

Statistical Analysis

The t-test was applied for the statistical analysis of the data and was conducted with a Mann-Whitney t-test using Prism software. Signal:noise ratios were calculated as the (Mean OD value of virus control wells)/(Mean OD value of cell control wells), and were calculated for each 96-well plate used for these experiments.

In summary, the present invention demonstrates that HAV infection can be detected in microplate-based cultures of FRhK-4 cells after only three days, instead of the typical 14-21 days required in other assays. Additionally, the present invention demonstrates that the presence of functional, HAV-neutralizing antibodies can be detected within this brief 2 to 3 day time period as well. An advantage of the method described herein is that rapid measurements of the immunogenicity of HAV vaccines and/or of immunogenic compositions, virological studies can be obtained, and for diagnostic purposes, as well as for research and development, for assessment of candidate immunogenic compositions based on HAV.

All documents noted herein are incorporated by reference in their entirety.

The above-described embodiments of the present invention are intended to be examples only. Alterations, modifications and variations may be effected to the particular embodiments by those of skill in the art without departing from the scope of the invention, which is defined solely by the claims appended hereto.

1. A rapid in vitro method for detecting hepatitis A virus (HAV) neutralizing antibodies in sera comprising evaluating HAV neutralizing antibody response after exposure of HAV-permissive cells to the sera in combination with a rapidly replicating HAV.

2. The method of claim 1 wherein the rapidly replicating HAV comprises HM175/18f-HAV.

3. The method of claim 1 wherein sera is derived from a subject suspected of exposure to HAV infection, an HAV vaccine, or an immunogenic composition based on HAV used to elicit an HAV neutralizing antibody response.

4. The method of claim 1, wherein no more than one replication cycle of HAV is required to evaluate HAV neutralizing antibody response.

5. The method of claim 1, wherein the HAV-permissive cells are fetal rhesus monkey kidney FRhK-4 cells.

6. The method of claim 1, wherein evaluating HAV neutralizing antibody response comprises detecting HAV growth in said HAV-permissive cells with an antibody to a HAV-VP3 structural protein, wherein suppressed HAV growth is indicative of HAV neutralizing antibodies.

7. The method of claim 1, which is a microplate-based method.

8. The method of claim 1, wherein evaluating HAV neutralizing antibody response comprises comparing the ability of sera to neutralize HAV relative to a virus control value.

9. A rapid in vitro method for detecting hepatitis A virus (HAV) neutralizing antibodies in sera, the method comprising:
incubating the sera with a rapidly replicating HAV to form a sera-HAV mixture;
incubating the sera-HAV mixture with pre-seeded HAV permissive cells;
fixing the cells; and
detecting HAV-VP3 in cells by incubating the cells with an anti-HAV VP3 antibody;
wherein HAV-VP3 in cells is indicative of HAV growth in said cells; suppressed HAV growth being indicative of HAV neutralizing antibodies in sera.

10. The method of claim 9, wherein the cells are fetal rhesus monkey kidney FRhK-4 cells.

11. The method of claim 9, wherein the rapidly replicating HAV is a cytopathic variant of HAV.

12. The method of claim 11, wherein the cytopathic variant of HAV is HM175/18f-HAV.

13. The method of claim 9, wherein a detectable antibody to the anti-HAV VP3 antibody is used to detect HAV-VP3.

14. The method of claim 13, wherein the detectable antibody is horseradish peroxidase (HRP)-conjugated goat anti-mouse antibody.

15. A kit for detecting hepatitis A virus (HAV) neutralizing antibodies in sera comprising:
a rapidly replicating cytopathic variant of HAV for incubating with sera;
HAV permissive cells comprising fetal rhesus monkey kidney FRhK-4 cells for incubating with a mixture of sera and said cytopathic variant of HAV; and
an anti-HAV VP3 antibody.

16. The kit of claim 15, wherein the rapidly replicating cytopathic variant of HAV is HM175/18f-HAV.

17. The kit of claim 15, additionally comprising a cell fixative.

18. The kit of claim 15, additionally comprising a detectable antibody to the anti-HAV VP3 antibody.

19. The kit of claim 18, wherein the detectable antibody comprises HRP-conjugated goat anti-mouse antibody.

20. The kit of claim 15, additionally comprising instructions for use in detecting HAV neutralizing antibodies in sera.
